(19) United States
(12) Patent Application Publication
(10) Pub. No.: US 2004/0213221 A1
(43) Pub. Date: Oct. 28, 2004

(54) System and method for soft bandwidth

(76) Inventors: Seyhan Civanlar, Red Bank, NJ (US); Ryan Moats, Omaha, NE (US); Earle H. West, Morganville, NJ (US); Xiangqun Liu, East Brunswick, NJ (US)

Correspondence Address: GRAY CARY WARE & FREIDENRICH LLP, 2000 UNIVERSITY AVENUE, E. PALO ALTO, CA, 94303-2248, US

(21) Appl. No.: 09/761,265

(22) Filed: Jan. 16, 2001

(51) Int. Cl. H04L 12/28

(52) U.S. Cl. 370/389

(57) ABSTRACT

The invention affords a system and method for establishing one or more virtual backbone tunnels coupled with an existing network infrastructure and dedicated to a particular user for facilitating the transmission of soft bandwidth services across the network.

The present invention relates to bandwidth allocation and more particularly, to a system and method for enabling soft bandwidth services over an existing network infrastructure.

### BACKGROUND OF THE INVENTION

Traditionally, a user chooses a particular Internet Service Provider (ISP) for accessing the Internet to facilitate web browsing, and for receiving Internet e-mail, among other benefits. The data traffic model typically used by ISPs is to compute “destination-based” IP routes at each router. This practice is easy to manage, and scales to very large networks. It also serves certain applications like email, web browsing, and instant messaging very well. However, this practice of route determination leads to the creation of end-to-end routes that have unpredictable and variable route characteristics. This variability in the dynamic selection of routes through the core network makes the present art of network routing unacceptable for the purposes of leasing wholesale units of capacity of the core network to other business entities. In addition, the variance in performance and path selection must be tightly controlled to serve certain new types of IP traffic, including voice, certain VPN services, and other connection-oriented services. The current art of using ATM or Frame Relay switching technologies to address the same problems (i.e. unacceptably varying end-to-end transmission qualities) impose additional non-IP network management complexity and at the same time introduce unwanted artifacts of a sub-optimal packet size for the transportation of IP packets.

With the tremendous growth of the Internet in the last decade, it is becoming more attractive for service providers to route point-to-point traffic onto existing Internet backbones to reduce cost, improve scalability and facilitate network management. The point-to-point traffic model carries fixed-route traffic. The data traffic is brought into and delivered from an IP network at known ingress and egress points within the network. Lately, there has been increasing fixed-route traffic demand by many network users, and therefore ISPs desire to have better control over their fixed-route traffic in order to distinguish their services in the marketplace and provide better service level agreements (SLAs) to meet customer requirements. An SLA is a contract between a network service provider and a customer that specifies, usually in measurable terms, what services the network service provider will furnish.

The desire for ISPs to have better control over their fixed-route traffic is largely related to the recent introduction of competitive local exchange carriers (CLECs). A CLEC is a telephone company that competes with an incumbent local exchange carrier, such as a regional Bell operating company, or other telephone companies, such as GTE, ALLNET, etc. Since the passage of the Telecommunications Act of 1996, there has been an explosion in the number of CLECs offering competitive services to customers.

The incumbent local exchange carriers have established a large telecommunications infrastructure to provide telecommunications services to their customers. CLECs can take advantage of this existing infrastructure in different ways. For example, CLECs typically take advantage of the availability of unbundled network elements (UNEs) made available through a co-location arrangement between various telecommunications providers. UNEs encompass any facility or equipment used in the provision of a telecommunications service, as well as telecommunications features, functions, and capabilities that are provided by means of such facilities or equipment. For CLECs, the most important UNE available to them is the local loop, which connects incumbent local exchange carriers' network switches to their present customers equipment. Using the existing local loop, CLECs are able to connect their own network switches with the incumbent local exchange carriers' network switches, giving them access to all of the incumbent local exchange carriers' customers.

Another important aspect to CLEC telecommunications networking is the ability to resell services. According to the Telecommunications Act any telecommunications services that are offered by incumbent local exchange carriers at retail must also be offered to CLECs at a wholesale discount. This saves the CLECs from having to invest in infrastructure elements, such as switches, fiber optic transmission facilities, or co-location arrangements.

Unfortunately, many CLECs, whose IP networking needs are similar to those of rapidly growing ISPs, view the large-grain and relatively inflexible networking capabilities of national transport providers as costly barriers to their own national service aspirations. Having to acquire traditionally large units of IP capacity with fixed design and performance parameters to span multiple regional networks, makes realization of particular economies of scale problematic for virtually all but the very largest CLECs. This particular problem restricts the ability of CLECs to effectively service potential customers. Accordingly, there is a need for a system and method that is able to supplement the large-grain and relatively inflexible networking capabilities of the national transport providers. It is to these ends that the present invention is directed.

### SUMMARY OF THE INVENTION

The invention affords a system and method for establishing one or more virtual backbone tunnels coupled with an existing network infrastructure and dedicated to a particular user for facilitating the transmission of soft bandwidth services across the network. In one aspect the invention affords a soft bandwidth service infrastructure coupled with an existing network infrastructure for carrying soft bandwidth traffic across the network. The soft bandwidth service infrastructure includes a means for defining one or more soft bandwidth segments between predetermined points on the existing network infrastructure. The defining means may utilize Multiprotocol Label Switching (MPLS) to define the soft bandwidth segments. The infrastructure also includes a means for integrating the soft bandwidth segments to establish one or more virtual backbone tunnels coupled with the existing network infrastructure, and a means for transmitting data traffic across the network such that soft bandwidth traffic is carried across the one or more virtual backbone tunnels and routine network data traffic is carried across the existing network infrastructure.

The existing network infrastructure may be a Fiber-optic IP backbone network and may include a plurality of core network routers interconnecting a plurality of facility stations, and a plurality of exchange routers for enabling access to the existing network infrastructure and for aggregating data traffic to respective core routers within the network infrastructure. One or more service providers, such as CLECs, may be connected with the network infrastructure via respective ones of the exchange routers.

Soft bandwidth segments may be defined between respective exchange routers in the existing network infrastructure. Accordingly, respective exchange routers may operate as ingress and egress label switched routers for routing soft bandwidth traffic across the one or more virtual backbone tunnels defined between them, and the core routers associated with the one or more virtual backbone tunnels may operate as label switched routers for routing the soft bandwidth traffic across the virtual backbone tunnels. The virtual backbone tunnels may be MPLS tunnels coupled with the existing network infrastructure and may be established across the existing network infrastructure using an MPLS signaling protocol such as Resource ReserVation Setup Protocol (RSVP). The virtual backbone tunnels may be managed according to the Lightweight Directory Access Protocol (LDAP).

The Fiber-optic IP backbone network may run an interior gateway protocol for routing data traffic within the network, and an internal border gateway protocol for external data traffic routing. The interior gateway protocol may be Open Shortest Path First (OSPF), or Intermediate System—Intermediate System (IS-IS).

In another aspect, the invention provides a system for establishing virtual backbone tunnels coupled with an existing network infrastructure to carry soft bandwidth traffic. The system includes a traffic matrix collector for maintaining network bandwidth traffic information, a route optimizer for determining soft bandwidth availability within the network and for determining an explicit soft bandwidth traffic path across the network in accordance with the network bandwidth traffic information, a network information database, such as an LDAP database, for maintaining updated soft bandwidth network configuration information relating to the determined soft bandwidth path, a means for informing particular components of the network infrastructure of the soft bandwidth network configuration information, and a means for establishing one or more virtual backbone tunnels across predetermined points in the network in accordance with the soft bandwidth network configuration information.

A database may be associated with the route optimizer and may include point-to-point bandwidth demand information relating to the network and updated network equipment and connection inventory information. In response to soft bandwidth allocation demands the route optimizer may determine a set of user-specific virtual backbone tunnels across the network in accordance with the point-to-point bandwidth information and updated network equipment and connection inventory information to satisfy the demands. The route optimizer may utilize the Floyd-Warshall shortest path algorithm to calculate an optimal soft bandwidth traffic path across the network.

The system may also include an order entry module for receiving soft bandwidth service requests by users of the network indicating particular soft bandwidth attributes, such as bandwidth allocation information, timing information, quality of service information, restorability information, and priority and preemption information. The system may also include a tunnel monitor for monitoring operation of the one or more virtual backbone tunnels in the network.

In another aspect the invention affords a method for transmitting data packets across a virtual backbone tunnel coupled with an existing network infrastructure. The method comprises the steps of determining a soft bandwidth traffic path across the existing network infrastructure, establishing a virtual backbone tunnel between predetermined points in the existing network infrastructure defining the soft bandwidth traffic path across the existing network infrastructure, assigning an identifier label to data packets entering the virtual backbone, and transmitting the data packets across the virtual backbone in accordance with the identifier label. The identifier label indicates routing information, address information, application information, and service information. The routing information includes any of destination information, bandwidth information, and timing information. Outgoing identifier labels are also associated with the data packets.

In still another aspect, the invention affords a method for establishing a virtual backbone tunnel coupled with an existing network infrastructure by receiving a request for a soft bandwidth service, the request indicating particular soft bandwidth attribute information, determining soft bandwidth availability within the network, determining an explicit soft bandwidth traffic path within the network, informing particular components of the network infrastructure of the soft bandwidth traffic path information, signaling the network to establish a virtual backbone tunnel between predetermined points in the existing network infrastructure indicated by the soft bandwidth traffic path information, and transmitting soft bandwidth data traffic relating to the requested soft bandwidth service across the virtual backbone tunnel.

The soft bandwidth attribute information includes any of bandwidth allocation information, timing information, quality of service information, restorability information, and priority and preemption information. Explicit soft bandwidth traffic path information may be stored in a network information directory, and a network exchange router may retrieve the soft bandwidth traffic path information from the network information directory. Signaling may be performed by encoding label information into an IP packet header at an ingress network exchange router and passing the label information to core network routers in accordance with the MPLS protocol.

### BRIEF DESCRIPTION OF THE DRAWINGS

FIG. 1A is a diagram illustrating an existing IP backbone over which a virtual backbone network may be overlaid in accordance with the invention;

FIG. 1B is a diagram illustrating a virtual IP backbone network which may be integrated with the existing IP backbone network shown in FIG. 1A to afford soft bandwidth tunneling in accordance with the invention;

FIG. 1C is a diagram illustrating a virtual IP backbone network overlaid over an existing IP backbone network to facilitate soft bandwidth tunneling in accordance with the invention;

FIG. 2 is a flowchart illustrating a preferred method for initiating a soft bandwidth order in accordance with the invention;

FIG. 3 is a diagram of a system for enabling soft bandwidth ordering in accordance with the invention;

FIG. 4 is a flowchart illustrating a preferred operation of the optimizer in accordance with the invention;

FIG. 5 is a diagram illustrating a preferred bandwidth optimization algorithm used by the invention;

FIG. 6 is an exemplary screen shot of a user interface that may be presented to a user upon accessing the service portal shown in FIG. 3;

FIG. 7 is a diagram illustrating an exemplary directory information tree that may be utilized by the network information database shown in FIG. 3;

FIG. 8 illustrates an association of a distinguished name for a particular object in the directory information tree of FIG. 7;

FIG. 9 is a diagram illustrating a possible LDAP directory structure for representing relevant information pertaining to a particular organization; and

FIG. 10 is a diagram illustrating FEC to LSP mapping in accordance with the invention.

### DETAILED DESCRIPTION OF THE PREFERRED EMBODIMENT

In accordance with the invention, one or more virtual IP-backbone networks may be established over an existing network infrastructure each dedicated to a particular user. These virtual networks may preferably be managed using advanced Lightweight Directory Access Protocol (LDAP) technology, for example, which will be described in detail below. Briefly, LDAP is a set of protocols for accessing information directories. LDAP is based on the X.500 standard (an ISO and ITU standard that defines how global directories should be structured), but is simpler to implement. Those skilled in the art will recognize that other technologies may be used to manage the virtual networks as well.

In accordance with the invention, Multiprotocol Label Switching (MPLS) technology is preferably used to define soft bandwidth segments between network points that, when integrated, may form virtual backbones on an existing network infrastructure. MPLS is an IETF (Internet Engineering Task Force) initiative that provides for the creation of an IP network having specific and assured characteristics for bandwidth, latency, and utilization between a specific pair of IP switches, using only IP addressing techniques. This effectively makes Layer 2 protocol information about network links (i.e., bandwidth, latency, utilization, etc.) controllable by Layer 3 protocol information (i.e., IP with label switching). This MPLS technique works pair-wise between switches within a particular autonomous system (i.e., an ISP) and is known to simplify and improve IP data packet exchange within a network. MPLS gives network operators a great deal of flexibility in diverting and routing traffic around link failures, congestion, and bottlenecks in the existing network. Advantageously, from a quality of service (QoS) standpoint, ISPs using MPLS technology are better able to manage different kinds of data streams (i.e., audio, video, etc.) based on established priority and service plans. For instance, users who subscribe to a premium service plan for a particular ISP, or users who may receive a lot of streaming media or high-bandwidth content may experience minimal latency and packet loss when using MPLS technology depending on the service plan.

When data packets enter a MPLS-based network, label edge routers typically assign them a label (an identifier). These labels contain information based on a routing table entry (i.e., destination, bandwidth, delay, and other metrics), and also refer to the data packet IP header field (source IP address), the application(s) involved (i.e., Layer 4 socket number information), and differentiated service information. Once this classification is complete and mapped, different data packets are assigned to corresponding label switched paths (LSPs), where label switch routers place outgoing labels on the data packets. Using these label switched paths, network operators can divert and route network traffic based on data-stream type and Internet-access customer among various other criteria.

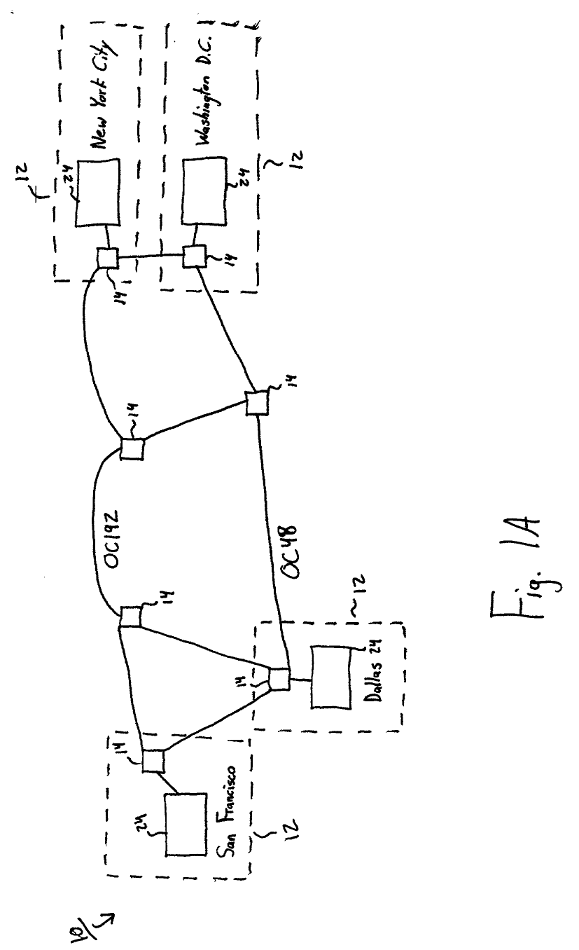

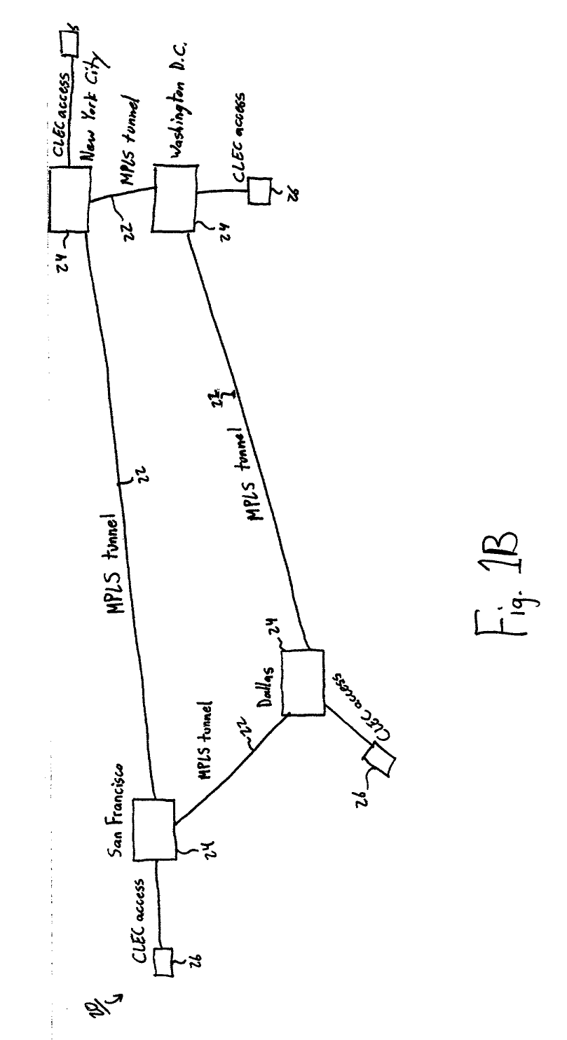

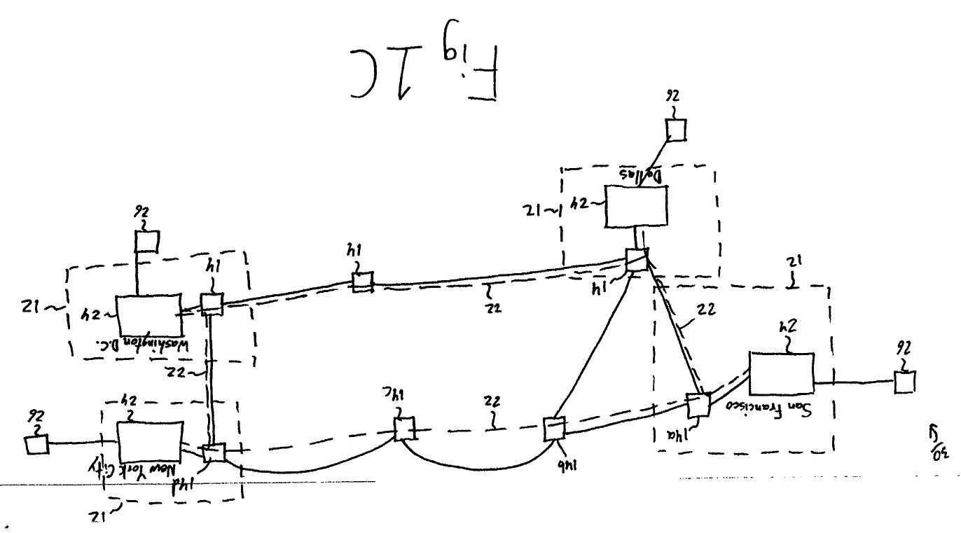

With the present invention, a soft bandwidth service infrastructure may be constructed by utilizing multiple uni-directional MPLS pairs in a coordinated manner in combination with various other components used to coordinate their operation, maintenance, and provisioning. FIGS. 1A and 1B are diagrams showing a typical service infrastructure capable of delivering soft bandwidth service. In FIG. 1A, the physical backbone 10 of a network infrastructure may be a Fiber-optic IP backbone 10 that may be constructed on top of SONET (Synchronous Optical Network) networks, for example, or any other network architecture. SONET is an ANSI standard for connecting fiber-optic transmission systems. The standard defines a hierarchy of interface rates that allow data streams at different rates to be multiplexed.

The IP backbone network 10 may allow for peering with other tier-1 ISPs to provide Internet services to the various users of the network, and may have its own hosting/content service as well. The backbone 10 may have high-speed facilities operating at line rates of OC12 and above for delivering soft bandwidth services. Some different line rates are exemplified in FIG. 1A. The backbone 10 may be constructed by interconnecting various fiber optic facilities 12 across core routers 14. These core routers 14 may reside, for example, in various backbone provider's gateway offices at major cities within the network, such as San Francisco, Dallas, Washington, D.C., and New York City. Accordingly, the network may be nationwide, or even global. Edge routers (not shown) may also be part of the network. The edge routers traditionally handle customer access to the network and aggregate traffic to the core routers 14. Preferably, the network may run an interior gateway protocol, such as open shortest path first (OSPF) or intermediate system—intermediate system (IS-IS) for its infrastructure protocol, and may use an internal border gateway protocol to carry external routing information.

FIG. 1B shows a virtual IP backbone 20 that may be formed by establishing MPLS tunnels 22 across the existing network infrastructure, for example, to constitute the soft bandwidth IP backbone shown in FIG. 1C, via overlaying the virtual network 20 (FIG. 1B) on top of the Fiber-optic IP backbone 10 (FIG. 1A). The virtual IP backbone 20 can serve a user's soft bandwidth needs by providing virtual backbones to users who may have large amounts of fixed-route traffic. Advantageously, the virtual IP backbone 20 is closely coupled with the Fiber-optic IP backbone 10 underneath to provide normal Internet service to accommodate a user's destination-based traffic.

Referring to FIGS. 1A and 1B, exchange routers 24 function as “meet-me points” located in major gateway offices 12 (such as in those cities exemplified above) to interconnect various CLECs to the IP backbone provider's network and to each other. Accordingly, the exchange routers 24 form virtual backbone ingress and egress label switched routers within the network. That is, the exchange routers 24 function as ingress and egress routers of an MPLS tunnel 22. CLEC access routers 26 attach to the virtual backbone 20 via an access connection, which runs between a CLEC access router 26 and an exchange router 24.

A CLEC may connect to the virtual backbone network 20 at the exchange routers 24. MPLS tunnels 22 that span across pairs of exchange routers 24 form a CLEC's network backbone via various core routers 14. For example, in FIG. 1C, which illustrates the virtual backbone network 20 of FIG. 1B overlaid over the existing infrastructure backbone 10 of FIG. 1A, the MPLS tunnel 22 that spans between San Francisco and New York City traverses core routers 14a, 14b, 14c, and 14d. The MPLS tunnel's route information can be “pushed” into ingress exchange router 24a, which in turn establishes an MPLS tunnel 22 across the Fiber-optic IP backbone 10 (FIG. 1A) by using MPLS signaling protocols such as Resource ReserVation Setup Protocol (RSVP), for example. RSVP is an Internet protocol developed to enable the Internet to support specified qualities of service. Using RSVP, an application can reserve resources along a route from source to destination. RSVP-enabled routers can schedule and prioritize packets to fulfill a desired quality of service. These MPLS tunnels 22 are used to carry a user's soft bandwidth traffic across the network as will be described in more detail below.

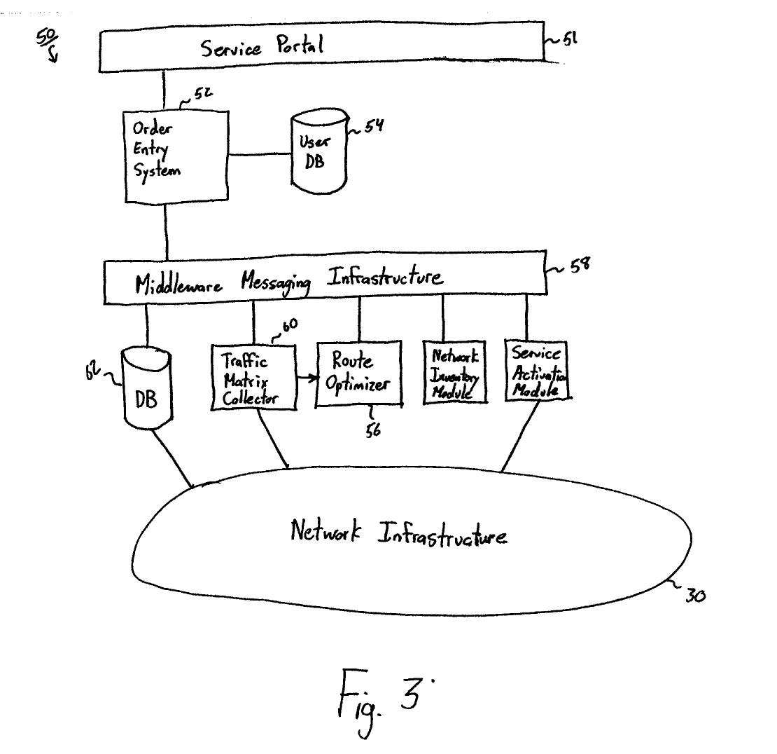

As mentioned, upon CLECs connecting to the existing Fiber-optic IP backbone network 10, soft bandwidth configuration for the CLECs using MPLS tunnels 22 can be established. Soft bandwidth configuring may include soft bandwidth ordering, performing MPLS route optimization, and utilizing directory-enabled activation. These aspects (among others) may be achieved by a soft bandwidth system 50 (shown in FIG. 3) which will be described in more detail below.

Soft bandwidth ordering will now be described. Soft bandwidth ordering results in the formation of MPLS tunnels 22 throughout the network 30 in accordance with soft bandwidth order entry information. Advantageously, order fulfillment may be controlled at the peripheries of the IP backbone 10 without burdening a service carrier's existing operations infrastructure. A user can subscribe to a soft bandwidth service offered by a service provider and obtain its own virtual backbone across the network. From the user's point of view, the virtual backbone appears as a real IP backbone. The user can define its desired performance objectives, such as bandwidth allocation, quality of service (QoS) level, and security parameters. A user can even run its internal gateway protocol across the virtual backbone. Additionally, the user can directly access the Internet from the virtual backbone using the same access link to the soft bandwidth service.

MPLS tunneling is advantageous over conventional network techniques for several reasons. Among them, MPLS tunneling allows for greater traffic routing control than can be accomplished using destination-based IP routing techniques. Additionally, the “soft” properties of a soft bandwidth tunnel provide particular capabilities that are very difficult to achieve using normal IP routing techniques. For example, MPLS tunneling allows network links to be explicitly selected to more efficiently utilize the available bandwidth in the network. MPLS tunneling also allows for rerouting of destinations to avoid active congestion points within the network. Load splitting and fast restoration of a damaged link can also be achieved. When needed, traffic may be split to multiple parallel soft bandwidth tunnels for traffic engineering purposes. Also, backup label switched paths can be pre-specified as hot-standby label switched paths to facilitate restoration of a corrupted network link. Accordingly, a soft bandwidth tunnel can be traffic engineered to achieve a better than normal IP “best effort” performance. Moreover, the data traffic of multiple users is not separated since they all share the same bandwidth tunnel, and packets having different IP precedence bits are not treated any differently than other packets.

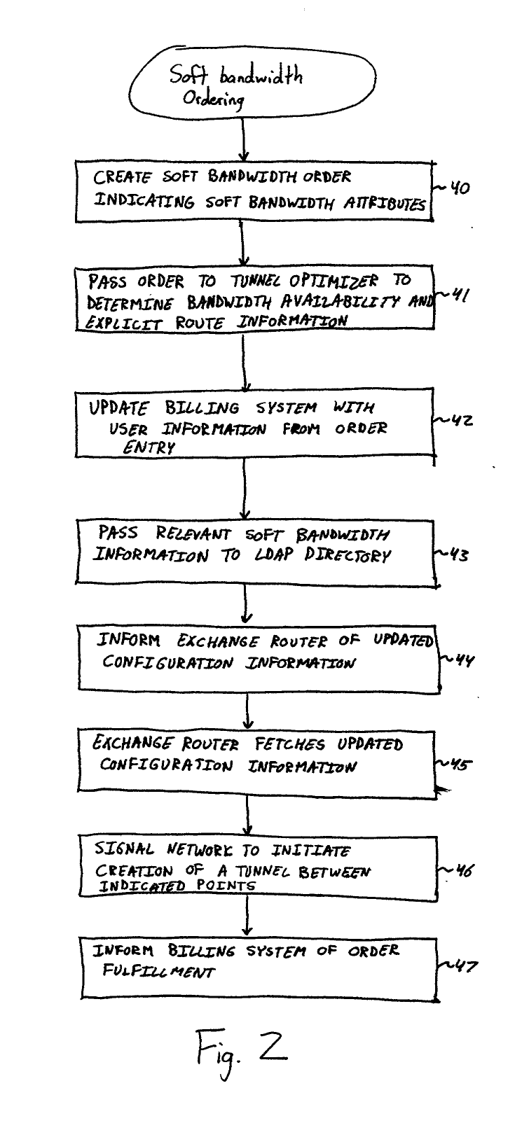

The following description highlights a preferred method for performing soft bandwidth ordering to initiate a soft bandwidth tunnel in accordance with the invention with relation to FIG. 2. As shown in FIG. 2, a method for initiating a soft bandwidth order may include various stages. Initially, a user may create a soft bandwidth order (Step 40) indicating specific soft bandwidth attributes, such as requested bandwidth allocation, ingress and egress exchange routers 24 in the network, duration of bandwidth utilization, associated quality of service level information, restorability, and priority and preemption information.

Subscribers to a soft bandwidth virtual network sometimes find it advantageous to agree in advance to release their claim to continued service in certain specified, but unlikely, conditions (e.g., a network cable cut or earthquake) that may impact service anywhere in the network. Having this type of subscriber enables the soft bandwidth service provider to reallocate the limited remaining backbone switching systems and data communications channels to other subscribers who have not agreed to any such release. This enables network providers to offer cost effective, but occasionally degraded, service to some subscribers, while extracting premiums from subscribers having needs for uninterruptable service. This capability extends to all attributes of a soft bandwidth service, including the continuity of an assured data rate, data latency, and service availability. A comprehensive set of agreements may address the sequence of service degradations for each subscriber (i.e., their priorities on a location-by-location basis) as well as the sequence of service restorations.

Accordingly, a user may create a soft bandwidth order entry using a service portal application running on a server (shown in FIG. 3 and described below). The order entry may be passed onto an MPLS tunnel optimizer (also shown in FIG. 3 and described below) for determination of soft bandwidth availability within the network and for a determination of a hop-by-hop explicit route within the network (e.g., the set of core routers 14 to handle the request) (Step 41).

An order entry system application (also shown in FIG. 3 and described below) may update a billing system with particular user information contained in the order entry (Step 42). After calculation of an appropriate MPLS tunnel route through the network, relevant soft bandwidth information may be passed onto a network information directory 62 (Step 43). In a preferred embodiment of the invention, the network information directory 62 is a collection of entries accessible via the LDAP protocol. Examples of the types of information that may be passed include service order information, a CLEC's ingress port on an exchange router 24, the set of addresses assigned to the CLEC's network (their IP address block), the collection of all MPLS tunnel path information defining the CLEC's network, and soft bandwidth attribute information (among other information). Accordingly, the ingress exchange router 24 may be informed of the updated configuration information in the directory (Step 44). The exchange router 24 may then fetch the updated configuration information (Step 45). Preferably, each network configuration is stored as a set of directory entries in the LDAP directory allowing potential reuse of directory entries and providing redundant storage of the current network configuration information in the directory. The ingress exchange router 24 may signal the network to initiate creation of an MPLS tunnel between indicated points (Step 46). These signals are embodied in standard labels that are encoded in the IP packet header at the exchange router 24 and passed through all network switches as provided for by the MPLS standard. The tunnel 22 is effectively created and may be used to carry traffic when the provisioning of the CLEC ingress link is complete. Finally, the billing system may be informed that order fulfillment is complete (Step 47).

FIG. 3 is a diagram illustrating a system 50 for enabling soft bandwidth ordering in accordance with the invention. The system 50 may include various components for facilitating soft bandwidth ordering that may be accessible to a user via a service portal 51. Such components may include an order entry module 52 for enabling a user to initiate a soft bandwidth order request from a service provider, such as a CLEC. The order entry module 52 may be customized for each service provider. An order request from a user may indicate specific soft bandwidth attributes, such as requested bandwidth allocation, particular network ingress and egress exchange routers 24 between which a soft bandwidth tunnel may be formed, duration of a soft bandwidth tunnel within the network, particular quality of service levels, restorability, and priority and preemption information. A user database 54 may be associated with the order entry module 52 for storing user orders and other user-specific information therein. A billing module (not shown) for updating a user's billing record with particular information contained in an order entry may also be provided.

An order entry may be generated by a user accessing the order entry module 52 and may be passed to a route optimizer 56 via a middleware messaging infrastructure 58 for determination of soft bandwidth availability, and the determination of an explicit hop-by-hop route within the network (e.g., the set of core routers 14 within the network infrastructure to handle the request). The route optimizer 56 is loaded with all point-to-point bandwidth requirements for all subscribers, and current network equipment and connection inventory information via the middleware messaging infrastructure 58 using data first collected by the traffic matrix collector 60 and the network inventory module. Once loaded with this data, the route optimizer 56 computes the required set of subscriber-specific MPLS tunnels and their individual properties, including routes, as required to meet the demands of all the subscribers. The route optimizer 56 calculates an overall optimal cost set of MPLS subscriber routes, subject to the practical constraints of available network equipment and connection inventory.

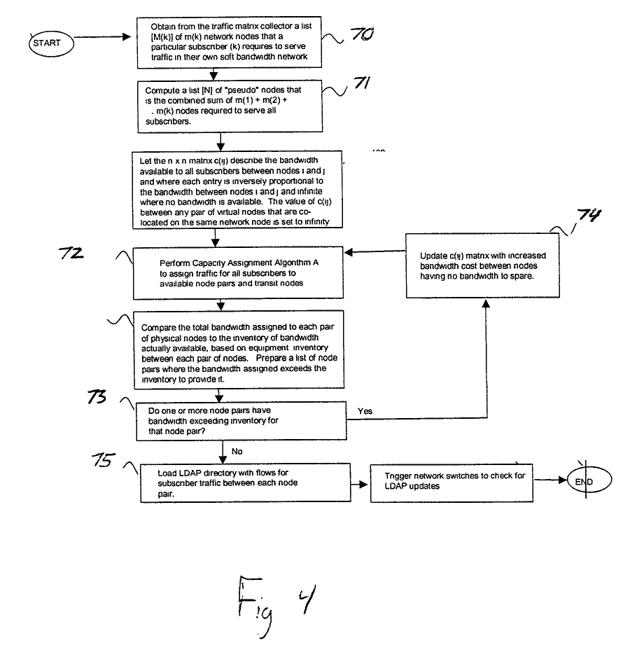

Various methods may be used by the route optimizer 56 to compute all of the needed MPLS tunnels from this subscriber demand data, assuming the network has adequate capacity to serve all of the demands presented. One such algorithm is shown in flowchart format in FIG. 4. Initially, the route optimizer 56 collects individual traffic demands from all of the subscribers (Step 70). Preferably, the route optimizer 56 obtains a list of network nodes from the traffic matrix collector 60 that a particular subscriber requires to serve traffic in their own soft bandwidth network. For example, from the traffic matrix collector 60, a list [M(k)] of m(k) network nodes that a particular subscriber (k) requires to serve traffic in their own soft bandwidth network may be obtained. Individual subscriber demands may be aggregated into a single matrix (Step 71). For example, a list [N] of “pseudo” nodes can be computed that is the combined sum of m(1)+m(2)+m(k) nodes required to serve all subscribers. An optimal bandwidth assignment (according to available inventory) may be made for an aggregate set of bandwidth demands generated by subscribers (Step 72).

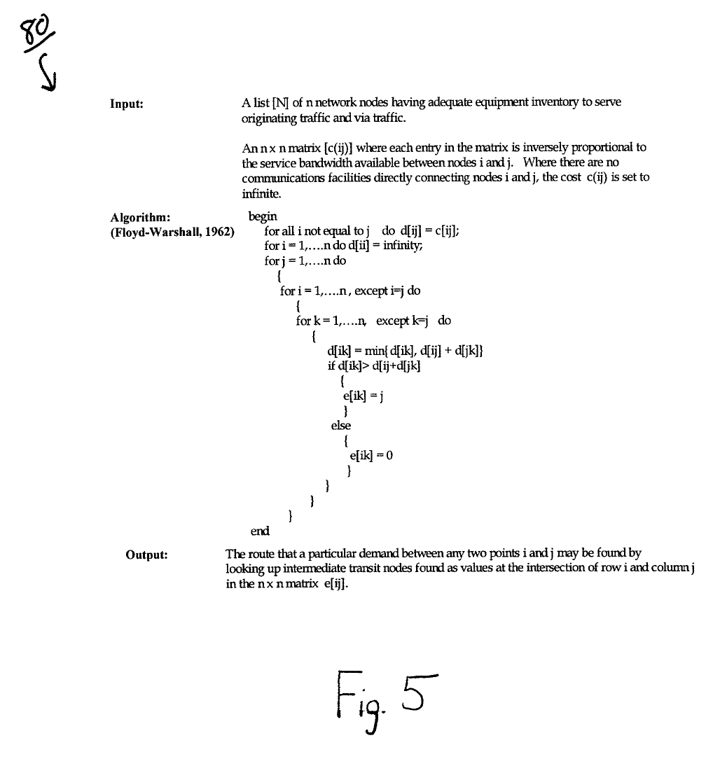

Those skilled in the art of network optimization will recognize that many different algorithms may be used to calculate an optimal bandwidth assignment for particular equipment and communications channels. Preferably, the invention utilizes the Floyd-Warshall shortest path method to compute the shortest path through a particular network. This algorithm 80 is illustrated in FIG. 5. Returning to FIG. 4, accordingly, a cost matrix may be computed using a predetermined cost figure for communications facilities that is inversely proportional to the bandwidth available between pairs of network switching nodes. Between switching nodes where no inventory of communications bandwidth is available, the cost may be set to infinity. This cost matrix may be used by the assignment algorithm to determine an optimal bandwidth assignment solution to meet a customer's bandwidth demand.

The aggregate assignment of subscriber bandwidth may require dynamic reconfiguration if the constraint-free cost-based assignment of the Floyd-Warshall algorithm results in the over-utilization of bandwidth between specific pairs of switching nodes. Accordingly, if over-utilization of bandwidth is detected (Step 73), the cost matrix may be updated to reflect higher costs for such links (Step 74) and the optimization step and testing may be repeated. This cycle may be repeated many times until all subscriber bandwidth demands are adequately served within the constraints of the network equipment inventory and communications channels between every pair of network switching nodes. At such time, tunnel creation can be completed (Step 75), for example, by loading the directory 62 with traffic flow information between each node pair (i.e., tunnel) and triggering the network switches to check for directory updates.

In an alternative embodiment of the invention, the route optimizer 56 may present its data to an expert network designer using a graphical user interface. The network designer may observe the progress of the route optimizer's performance (i.e., executing the above algorithm) and may optionally manually adjust the network cost figures to hasten the convergence of the algorithm. However, in the preferred embodiment of the invention, the assignment algorithm operates very rapidly and can compute new MPLS routes for all individual subscriber demands within a short period of time (i.e., seconds, at most). Accordingly, such rapid determination of optimal bandwidth assignment enables orders for new soft bandwidth services to be immediately realized on the network.

Returning again to FIG. 3, the middleware messaging infrastructure 58 provides a secure bus for enabling the system components to communicate with each other. This bus enables the identification of each of the communicating components and facilitates efficient transmission of private data between any two points on the bus. The traffic matrix collector 60 may be a processor that stores and provides to the route optimizer 56 all point-to-point subscriber demands placed on the entire soft bandwidth infrastructure. While some demands may be for soft bandwidth requirements, the network may also be shared with highly variable network traffic. The traffic matrix collector 60 may use historical data of the variable traffic as a means for predicting current and future traffic demands across the network. Accordingly, the traffic matrix collector 60 may store and combine predicted demands with fixed demands for soft bandwidth services to compute the network's point-to-point traffic requirements.

After an appropriate route through the network infrastructure 30 is determined by the route optimizer 56, relevant soft bandwidth information, such as a particular CLEC's ingress port on an exchange router 24 and an IP address block, hop-by-hop MPLS tunnel path information, and soft bandwidth information, may be passed onto a network information database 62. Preferably, the network information database 62 is an LDAP database. This database 62 and its preferred LDAP directory structure will be described in more detail below.

MPLS tunnels are implemented in the network by distributing new (or updated) label-switching entries to each router in the network. This distribution of data may occur at scheduled periodic intervals and/or at the time that packets having an MPLS header are received by each router. In the later case, label-switching table entries may be obtained from a response to an LDAP query to a centralized data store, and cached locally at each network switch along with time-to-live data that limits the length of time such data should be cached. In any case, when new IP packets arrive at a particular router, the router first looks for MPLS headers on arriving packets and (for those packets) refers to a local MPLS table to determine the route to take and the new label to be applied to an outgoing IP packet. If a packet has no MPLS header, the Forward Equivalence Class (FEC) associated with the IP address is used to determine if MPLS labeling is to be applied by the router. For ingress routers, there is no MPLS label, but the FEC is used to determine that a) an MPLS header should be added, and b) a particular label should be used.

The exchange router 24 uses appropriate uses appropriate MPLS labels to signal the next router in the path to a) use MPLS data to compute the route, and b) select the particular MPLS data in a local table to select a specific route. Each router in the network signals the next router in the complete path until the egress router passes the IP packet to the selected router outside of the managed network. The sequence of routers used in a particular path is called an MPLS tunnel. Traffic through this MPLS tunnel may be monitored by a tunnel monitor (not shown) using test packets that pass through this tunnel.

MPLS tunnels may therefore be overlaid on top of an existing IP routing infrastructure to implement special treatment for specially-coded MPLS-labeled packets to use specific transmission facilities, routers, and therefore end-to-end tunnels. MPLS tunnels created in the manner are simplex paths. A complete solution implements MPLS tables that drive the definition of MPLS routing tables applicable to traffic in both directions. The special treatment of IP routing using MPLS tunnels, together with the distribution of MPLS routing instructions via a centralized direction (i.e., LDAP) aids in implementing soft bandwidth services.

Returning to FIG. 3, the designated ingress exchange router 24 may be informed of new configuration information which may be fetched by the exchange router 24 from the network information database 62. The exchange router 24 may signal the network for creation of an MPLS tunnel 22 within the network between particular ingress and egress points that may begin to carry data traffic when the provisioning of the CLEC ingress link is complete. The tunnel 22 operation may be monitored by a tunnel monitor (not shown).

The network inventory module 64 may store and provide to other system components information on the capabilities, capacity, and status of all of the equipment and communications channels available in the network. Information may be added to the network inventory module 64 when new equipment is added to the network, and/or when new pair-wise connections are added between locations on the network. Network inventory information may be conveyed from the network inventory module 64 to the route optimizer 56 via the middleware messaging infrastructure 58 when the route optimizer 56 requests the information. The service activation module 66 enables the activation of soft bandwidth services across the network.

While the above system has been described as various individual components, those skilled in the art will recognize that the system may be embodied as particular application modules running on a server, or may be distributed across several servers, which may be accessed by a user desiring to create a soft bandwidth order, as described above.

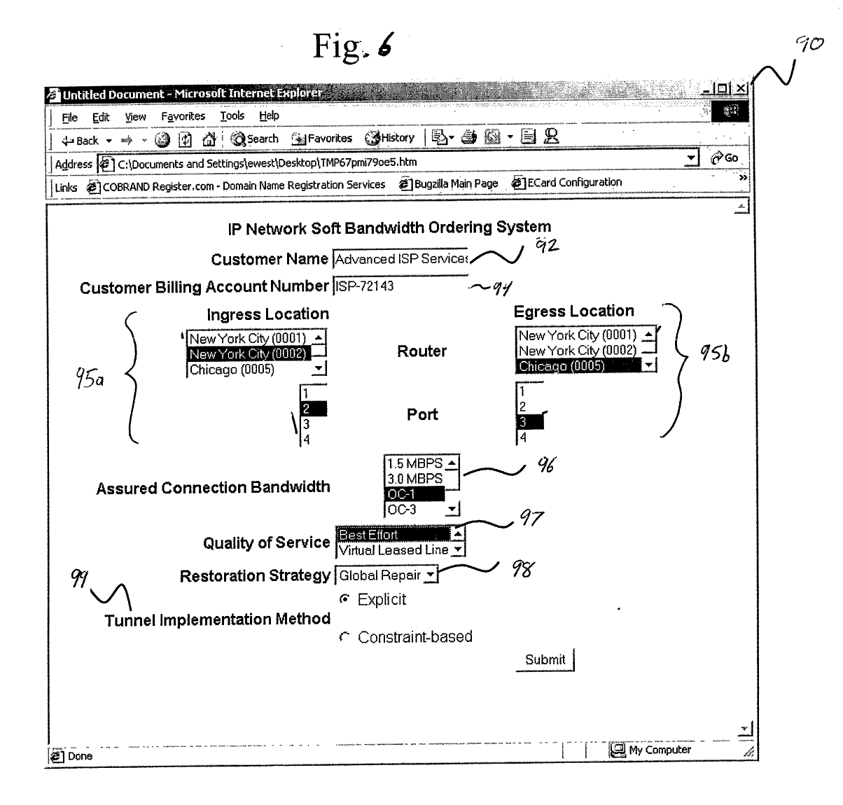

FIG. 6 is an exemplary screen shot of a user interface 90 that may be presented to a user accessing the service portal 51 (FIG. 3) when desiring to create a soft bandwidth order. The user interface 90 may include various options available to a user depending on the desirable interests of the user. For example, the interface 90 may include a data field 92 for entering the name of a customer, a data field 94 for entering a customer billing account number, and ingress and egress router selection menus 95a, 95b. The user interface 90 may also include an assured connection bandwidth selection menu 96 for allowing a user to choose a desired MPLS tunnel bandwidth. A Quality of Service selection menu 97, restoration strategy menu 98 and tunnel implementation method selector 99 may also be provided. Accordingly, a user can customize a soft bandwidth order by interacting with the user interface 90 and submitting the order to the system.

MPLS route optimization will now be described in detail. In accordance with the invention, the route optimizer 56 (FIG. 3) monitors network resource utilization to determine optimal soft bandwidth routes within the network infrastructure 30. Analysis may be based on a particular network topology and on the data traffic distribution within that particular topology. For example, network topology information may be gathered by the route optimizer 56 periodically from the IP backbone 30. Gathering of such information may be enabled, for example, by accessing the Fiber-optic IP backbone 30 via one or more exchange routers 24 and extracting the particular network topology utilized by querying the network configuration files of the core routers 14. After obtaining the network topology information, the route optimizer 56 may utilize the retrieved network topology information and related traffic matrix information to determine an optimal soft bandwidth route path within the network 30 that satisfies the requested parameters of the soft bandwidth order as described above.

As mentioned above, an advantageous aspect of the invention is the utilization of directory-enabled activation. Directory-enabled activation will now be described in detail. Preferably, the network information database 62 (FIG. 3) utilizes an LDAP directory structure. Advantageously, the LDAP directory structure supports improved storage redundancy via replication as well as improved scaling, as information transfers within the database 62 can occur from each of the replicated directories. In addition, new types of soft bandwidth services can be rapidly loaded into the network information via extensions provided in the directory schema. A preferred directory schema used by the invention for defining soft bandwidth services is established by extending the current directory enabled networking (DEN) schema developed by the Desktop Management Task Force (DTMF) and Internet Engineering Task Force (IETF).

Briefly, a directory enabled network facilitates the building of interoperable network solutions, via the exchange of management, operational and functional information. It also ensures interoperability with the network among different vendors. In addition, the network (equipment and services) can be managed as a whole, rather than on a piecemeal basis. For service providers, directory enabled networking provides the ability to differentiate their services in the marketplace based on the delivery of finely tuned end-to-end services. Such a network allows for the personalization of network services at any granularity (account, end-user, etc.)

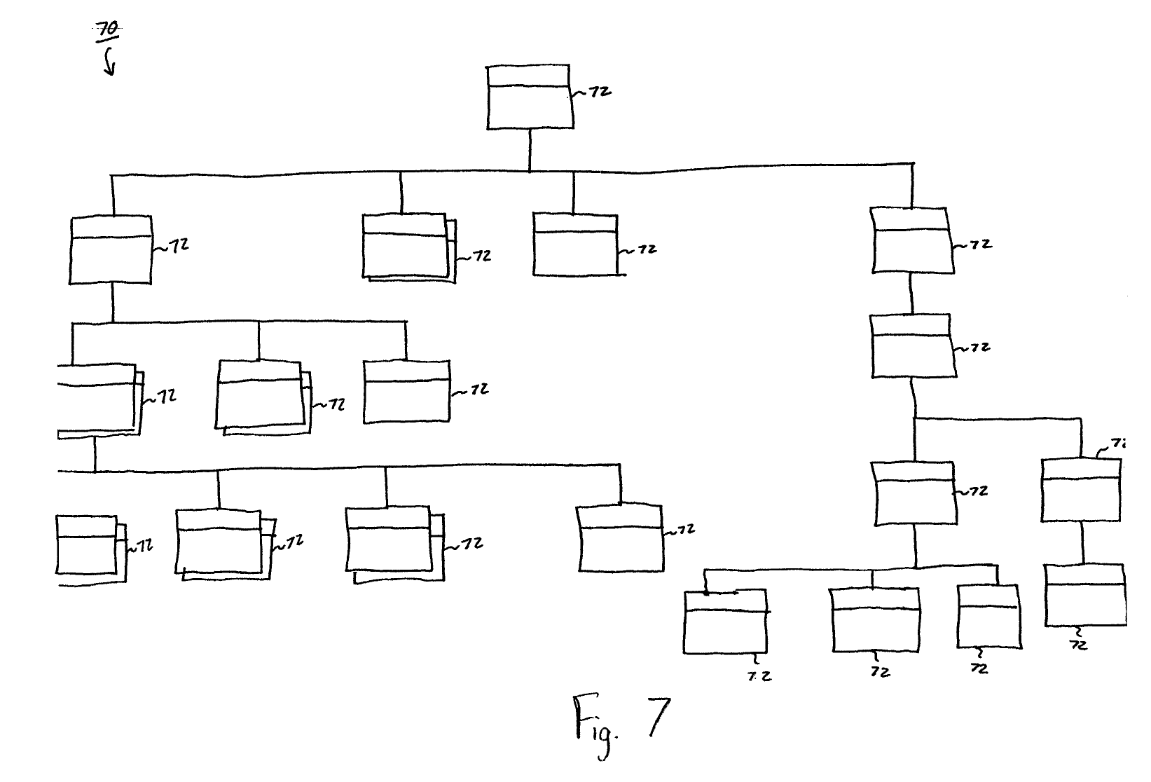

As described above, the directory enabled network of the present invention is preferably accessed according to the Lightweight Directory Access Protocol (LDAP). This protocol provides a hierarchical organization of entries (representing, for example, offered services and other aspects of a telecommunications service), referred to commonly as a directory information tree. An exemplary directory information tree is illustrated in FIG. 7. Each entry in the directory information tree 100 of FIG. 7, (represented in the drawing as a file icon 102) may be identified by a relative distinguished name (RDN) that distinguishes it from its sibling entries (entries that share the same parent entry). Each entry 102 may be uniquely identified by a distinguished name (DN) which may be generated by concatenating the RDN of the entry 102 with the RDNs of all of its parent entries 102 in the directory information tree 100.

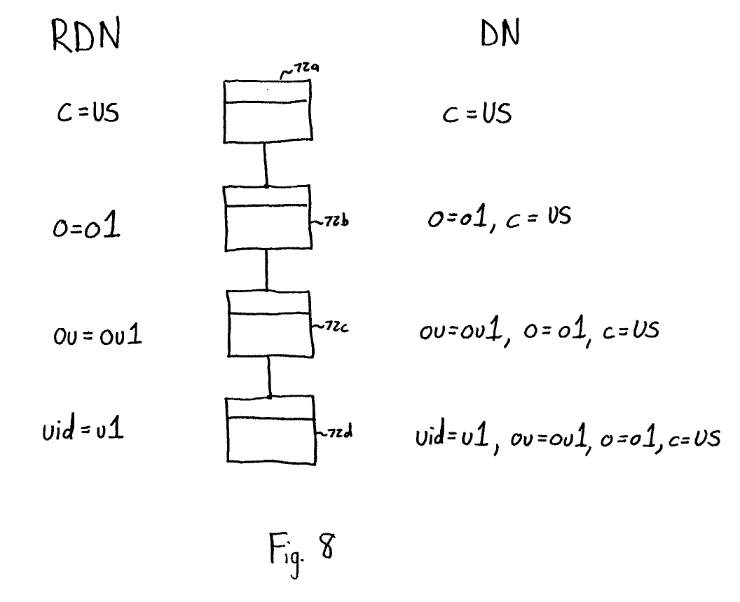

FIG. 8 illustrates the construction of a distinguished name for a particular entry 102 in the directory information tree 100. As shown in FIG. 8, an arbitrary example entry 102a in the directory information tree may have a RDN of c=US. Since this entry 102a is a root entry in the directory information tree 100, its DN is equivalent to its RDN (c=US) as there are no associated parent entries. Continuing this example, its child, entry 102b, may have a RDN of o=o1 and be uniquely identified by its DN, o=o1, c=US. Continuing this trend, entry 102c may have a RDN of ou=ou1 and may be uniquely identified by its DN, ou=ou1, o=o1, c=US. Likewise, entry 102d may have a RDN of uid=u1, and identified by its DN, uid=u1, ou=ou1, o-o1, c=US.

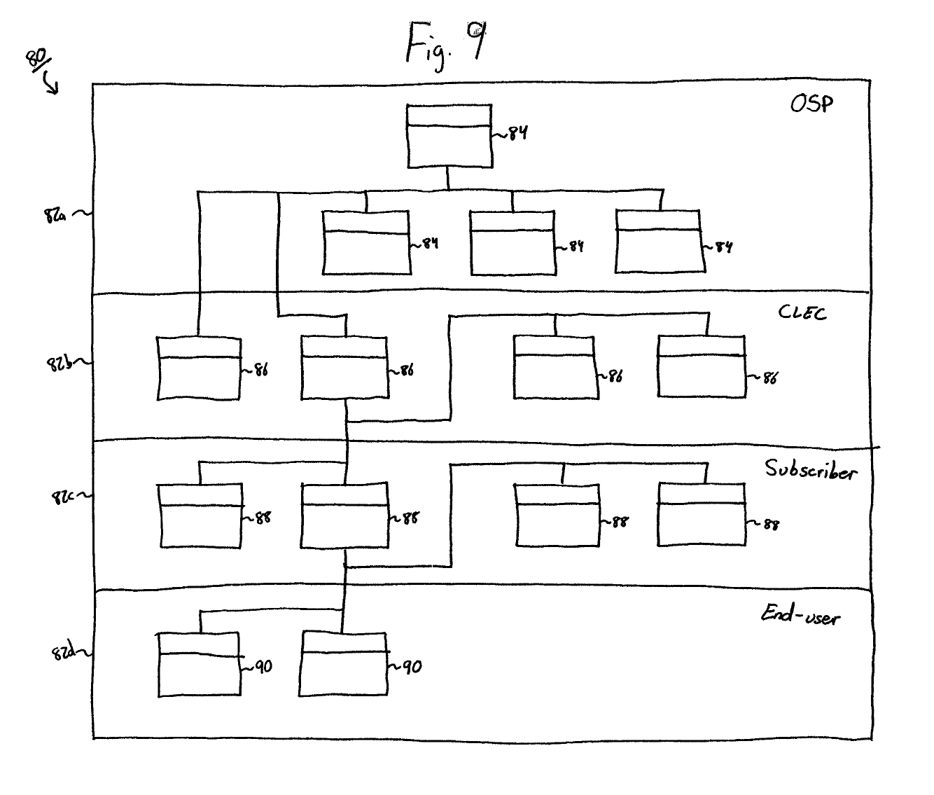

To take advantage of this means of organizing information in an LDAP directory structure, the directory is designed to take advantage of the level of interaction within a particular business to which the invention is applied. Consider, for example, a telecommunications business structure. A possible LDAP directory structure 110 for representing information pertaining to this business structure is shown in FIG. 9. The directory structure 110 may be made up of several layers 112a-d, each layer 112a-d representing a particular interaction level of an entity with the business. At the top layer 112a, an Operations Service Provider, from which a CLEC purchases network management services may be represented. A CLEC may be represented at a secondary layer 112b, and in turn sells services to its subscribers (for example, small businesses who desire to access the Internet via the CLEC's ISP network) represented at a third layer 112c in the directory structure 110. These subscribers may have individual end-users represented at a fourth layer 112d in the directory structure 110 that may be accessing the services the subscriber has bought from the CLEC.

Accordingly, the directory design 110 shown in FIG. 9 takes advantage of self-similarity in the structure of layers 112a-d to increase the flexibility of the directory. In addition, such a model naturally encourages CLECs and subscribers to use the same directory structure for their own internal management systems, thereby lowering their internal systems costs by reusing the same architecture and hardware. Also, in the case of a subscriber being a reseller, it is possible to extend the directory model to support a second subscriber layer between the CLEC and end-user layers.

In the directory model 110 shown in FIG. 9, the top layer 112a may contain general directory entries 114, such as management and provisioning entries, and template entries for specific services that a CLEC could decide to provide to its subscribers. Other service entries, such as those used by the CLECs for network management, may also be provided in the top layer 112a. Also, cross-CLEC service entries (such as roaming services) may be organized at the top layer 112a. Accordingly, a CLEC may choose the services from an OSP that they wish to provide to customers and establish relationships vis-à-vis other CLECs in an a la carte manner.

At the CLEC layer 112b, directory entries 116 may describe specifics of a CLEC's configuration, including services the CLEC has purchased from the Operation Service Provider. In addition, a CLEC can make available cross-subscriber service entries (i.e., extranets) at the second layer 112b. This ensures that individual subscribers can access these services while maintaining the confidentiality of subscriber information.

Directory entries 118 relating to individual subscribers may be stored at the subscriber layer 112c. In addition to the particulars of a service a subscriber may have purchased from the CLEC (i.e., the number of mailboxes and a mail storage quota for e-mail services), the third layer 112c may also include directory entries 118 indicating the parameters of cross end-user services (i.e., VPNs).

The lowest layer 112d in the tree structure 110 shown in FIG. 9, is the end-user layer 112d. Individual end-users may manage their own service subscription directory objects 120, including adding/removing services and modifying service parameters. This enables precise customization of individual services for individual end-users.

To illustrate the flexibility afforded by a directory enabled network, consider the example of provisioning static information for an explicitly specified MPLS tunnel. Tunnel data may be stored in an LDAP directory. Accordingly, when changes are made to tunnel data in the directory, a configlet generator may be signaled, which may retrieve the new data from the directory, build updated configuration information, and “push” that information into the designated ingress label switched router in the network. Advantageously, this model can be extended to supporting VPNs implemented over an MPLS device by including the desired VPN information in the generated configlet record.

An important metric of any system is cost control. The layered division of the exemplified directory enables self-management at all levels. Accordingly, a CLEC administrator may manage both the CLEC's own information as well as the broad parameters of its customers' information, while a subscriber to the CLEC's services may manage its own information and that of its particular customers. Any system supporting multiple business entities should maintain privacy of customer data. In addition to the horizontal strata discussed above, the LDAP directory structure has inherent vertical boundaries that ensure that a customer can only access its own data and that of its customers. This protects the privacy of customer data from potential competitors.

Network management, such as managing fault, performance, trouble and inventory information may be performed by a NOC system. The NOC system may manage network elements, physical media and connections, and end-to-end logical or virtual connections within the network. Fault management includes real-time and near real-time monitoring with an emphasis on proactively identifying network impairments. A fault management system may gather fault information from individual network components, isolate the root cause of a network outage, identify affected service providers and end customers, and generate events that can result in messages that are sent to appropriate repair technicians (trouble tickets).

Performance management supports the process of collection, analysis, thresholding, and reporting of performance data. Performance reports may be generated in various formats suitable for business managers, capacity planners, and NOC personnel. The performance reports may help service providers in strategy and capacity planning as well as for analyzing particular SLA measurements. They may also help the NOC system in troubleshooting an alarm or other reported trouble in the network.

A trouble management system supports problem tracking and accounting. It functions as a central repository for all knowledge concerning a particular problem from its identification as a problem to its correlation, evaluation, resolution, and closure. An inventory management system supports the process of configuring, creating, maintaining and reporting the topology data for a network configuration. Inventory information may be used to determine the equipment to be monitored for fault and performance management, as well as to help correlate events down to the end customer level.

The invention is particularly advantageous to those service providers who own substantial bandwidth served by use of Wavelength Division Multiplexing technology. Multiprotocol Label Switching offers the needed simplicity of dynamic bandwidth redefinition of this infrastructure without having to control transit nodes within a large network or needing a layer-2 overlay.

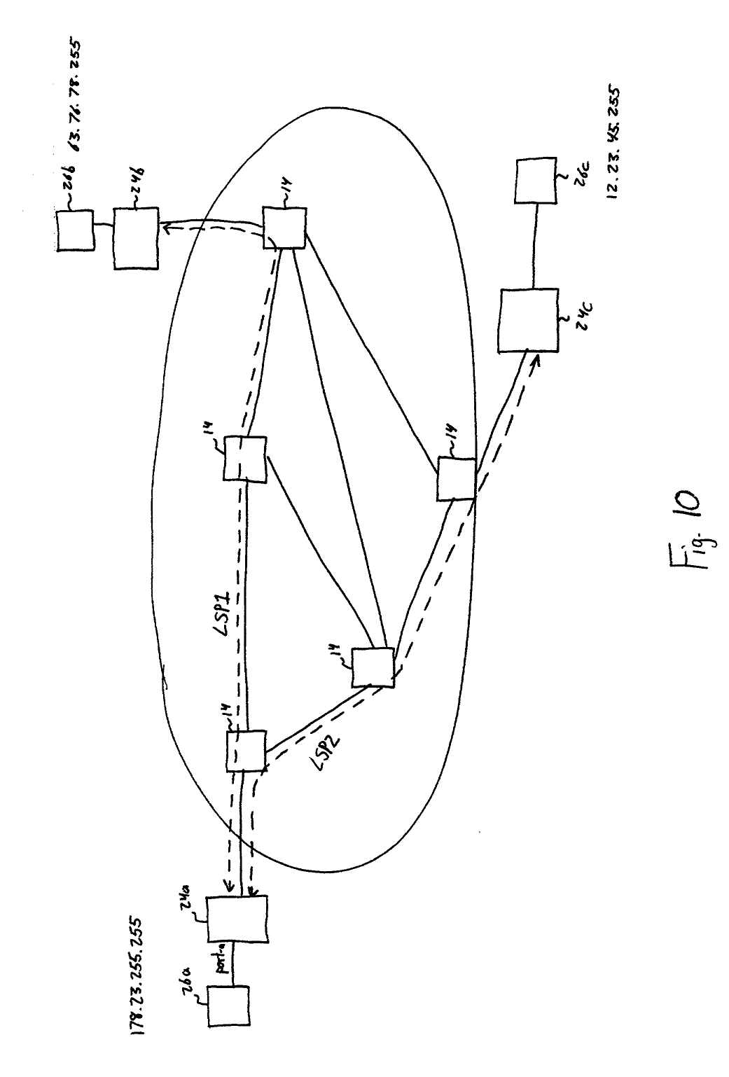

As described above with reference to FIG. 1C, the connectivity of a CLEC to the Fiber-optic IP backbone 10 is provided through a customer access router's connectivity to an exchange router 24. It should be noted that the exchange router 24 can be located in the same autonomous system as the Fiber-optic IP backbone network 10. FIG. 10 is a diagram illustrating forwarding equivalence class to label switched path mapping in accordance with the invention.

Since the ingress router uses FEC information to select the initial MPLS label treatment, a mapping between FEC and MPLS tunnels is implemented at the ingress router. As generally described above, simplex MPLS tunnels are created when a sequence of routers uses the MPLS data to select the outgoing route to be used (and an associated new MPLS label) to use in the MPLS header for IP packets. In FIG. 10, three different customer access routers 26a-c connect to an associated exchange router 24a-c. Consider two different MPLS tunnels 22 are established in FIG. 10 (labeled LSP1 and LSP2, respectively) between respective exchange routers 24. When a customer access router 26 connects to an exchange router 24, at port A for example, then traffic (from/to port A) is mapped onto different MPLS tunnels 22 (Label Switched Paths, i.e., LSP1, LSP2) based on IP address prefixes supported on the originating and destination CLEC IP networks. For example, in FIG. 10, the Exchange Router 24a is configured to forward outgoing traffic from port A to LSP1 or LSP2 based on destination IP addresses.

To illustrate, suppose customer access router 26a has an associated IP address of 178.23.255.255, customer access router 26b has an associated IP address of 63.76.78.255, and customer access router 26c has an associated IP address of 12.23.45.255. Accordingly, a mapping can be established to properly route information along MPLS tunnels within the network. For example, to route data from port A to customer access router 26c, a mapping record accessible by the exchange routers 24 may indicate LSP2 as the proper MPLS tunnel path within the network. Similarly, to route data from port A to customer access router 26b, a mapping record accessible by the exchange routers 24 may indicate LSP1 as the proper MPLS tunnel path within the network.

As mentioned above, formation of FEC to LSP mapping is preferably performed after the explicitly routed MPLS tunnel path 22 is configured on the designated ingress exchange router 24. Thereafter, RSVP signaling can be utilized to propagate the path of LSP1 and LSP2 (or any LSP path) across the Fiber-optic IP backbone 10.

The present invention has the capability to drastically change the economics of nationwide networking. Among its advantages, it may enable selected service providers to dominate the small CLEC networking market, and enable the smallest CLECs to have nation-wide service reach. While this would impact DSL-focused CLECs, it may also impact emerging wireless entrants.

The virtual backbones that may be established in accordance with the invention economically serve the needs of smaller telecommunications carriers who may avoid costly POPs (point of presence) and transport facilities. Additionally, this bandwidth architecture supports the definition of new bandwidth attributes. Quality of service, time duration, restorability, priority level and preemption provide superior means of differentiating service to carriers and end-users.

What is claimed is:

1. A soft bandwidth service infrastructure coupled with an existing network infrastructure for carrying soft bandwidth traffic across the network, comprising:
means for defining one or more soft bandwidth segments between predetermined points on the existing network infrastructure;
means for integrating the soft bandwidth segments to establish one or more virtual backbone tunnels coupled with the existing network infrastructure; and
means for transmitting data traffic across the network such that soft bandwidth traffic is carried across the one or more virtual backbone tunnels and routine network data traffic is carried across the existing network infrastructure.

2. The infrastructure of claim 1, wherein the existing network infrastructure is a Fiber-optic IP backbone network.

3. The infrastructure of claim 2, wherein the existing network infrastructure includes a plurality of core network routers interconnecting a plurality of facility stations, and a plurality of exchange routers for enabling access to the existing network infrastructure and for aggregating data traffic to respective core routers within the network infrastructure.

4. The infrastructure of claim 3, wherein one or more service providers are connected with the network infrastructure via respective ones of the exchange routers.

5. The infrastructure of claim 3, wherein the soft bandwidth segments are defined between respective exchange routers in the existing network infrastructure.

6. The infrastructure of claim 5, wherein respective exchange routers operate as ingress and egress label switched routers for routing soft bandwidth traffic across the one or more virtual backbone tunnels defined between them.

7. The infrastructure of claim 6, wherein the core routers associated with the one or more virtual backbone tunnels operate as label switched routers for routing the soft bandwidth traffic across the virtual backbone tunnels.

8. The infrastructure of claim 2, wherein the Fiber-optic IP backbone network runs an interior gateway protocol for routing data traffic within the network, and an internal border gateway protocol for external data traffic routing.

9. The infrastructure of claim 8, wherein the interior gateway protocol is Open Shortest Path First (OSPF).

10. The infrastructure of claim 8, wherein the interior gateway protocol is Intermediate System —Intermediate System (IS-IS).

11. The infrastructure of claim 1, wherein the defining means utilizes Multiprotocol Label Switching (MPLS) to define the soft bandwidth segments.

12. The infrastructure of claim 1, wherein the virtual backbone tunnels are MPLS tunnels coupled with the existing network infrastructure.

13. The infrastructure of claim 12, wherein the virtual backbone tunnels are established across the existing network infrastructure using an MPLS signaling protocol.

14. The infrastructure of claim 13, wherein the MPLS signaling protocol is Resource ReserVation Setup (RSVP).

15. The infrastructure of claim 1, wherein the virtual backbone tunnels are managed according to the Lightweight Directory Access Protocol (LDAP).

16. A system for establishing virtual backbone tunnels coupled with an existing network infrastructure to carry soft bandwidth traffic, comprising:
a traffic matrix collector for maintaining network bandwidth traffic information;
a route optimizer for determining soft bandwidth availability within the network and for determining an explicit soft bandwidth traffic path across the network in accordance with the network bandwidth traffic information;
a network information database for maintaining updated soft bandwidth network configuration information relating to the determined soft bandwidth path;
means for informing particular components of the network infrastructure of the soft bandwidth network configuration information; and
means for establishing one or more virtual backbone tunnels across predetermined points in the network in accordance with the soft bandwidth network configuration information.

17. The system of claim 16, wherein a database is associated with the route optimizer and includes point-to-point bandwidth demand information relating to the network and updated network equipment and connection inventory information.

18. The system of claim 17, wherein in response to soft bandwidth allocation demands the route optimizer determines a set of user-specific virtual backbone tunnels across the network in accordance with the point-to-point bandwidth information and updated network equipment and connection inventory information to satisfy the demands.

19. The system of claim 16, wherein the route optimizer utilizes the Floyd-Warshall shortest path algorithm to calculate an optimal soft bandwidth traffic path across the network.

20. The system of claim 16, wherein the network information database is an LDAP database.

21. The system of claim 16, further comprising an order entry module for receiving soft bandwidth service requests by users of the network.

22. The system of claim 21, wherein the soft bandwidth service requests indicate particular soft bandwidth attributes.

23. The system of claim 22, wherein the soft bandwidth attributes include any of bandwidth allocation information, timing information, quality of service information, restorability information, and priority and preemption information.

24. The system of claim 21, further comprising a tunnel monitor for monitoring operation of the one or more virtual backbone tunnels in the network.

25. A method for transmitting data packets across a virtual backbone tunnel coupled with an existing network infrastructure, comprising the steps of:
determining a soft bandwidth traffic path across the existing network infrastructure;
establishing a virtual backbone tunnel between predetermined points in the existing network infrastructure defining the soft bandwidth traffic path across the existing network infrastructure;
assigning an identifier label to data packets entering the virtual backbone; and
transmitting the data packets across the virtual backbone in accordance with the identifier label.

26. The method of claim 25, wherein the identifier indicates any of routing information, address information, application information, and service information.

27. The method of claim 26, wherein the routing information includes any of destination information, bandwidth information, and timing information.

28. The method of claim 25, wherein outgoing identifier labels are associated with the data packets.

29. A method for establishing a virtual backbone tunnel coupled with an existing network infrastructure, comprising the steps of:
receiving a request for a soft bandwidth service, the request indicating particular soft bandwidth attribute information;
determining soft bandwidth availability within the network;
determining an explicit soft bandwidth traffic path within the network;
informing particular components of the network infrastructure of the soft bandwidth traffic path information;
signaling the network to establish a virtual backbone tunnel between predetermined points in the existing network infrastructure indicated by the soft bandwidth traffic path information; and
transmitting soft bandwidth data traffic relating to the requested soft bandwidth service across the virtual backbone tunnel.

30. The method of claim 29, wherein the soft bandwidth attribute information includes any of bandwidth allocation information, timing information, quality of service information, restorability information, and priority and preemption information.

31. The method of claim 29, wherein explicit soft bandwidth traffic path information is stored in a network information directory, and wherein a network exchange router retrieves the soft bandwidth traffic path information from the network information directory.

32. The method of claim 29, wherein the signaling is performed by encoding label information into an IP packet header at an ingress network exchange router and passing the label information to core network routers in accordance with the MPLS protocol.
